(19) United States
(12) Patent Application Publication
(10) Pub. No.: US 2018/0029851 A1
(43) Pub. Date: Feb. 1, 2018

(54) LINKAGE ASSEMBLY FOR MACHINE

(71) Applicant: Caterpillar Inc., Peoria, IL (US)

(72) Inventors: Satish K. Polumati, Oswego, IL (US); Michael J. Braun, Oswego, IL (US); Adnan Shamim, Forest Park, IL (US)

(73) Assignee: Caterpillar Inc., Peoria, IL (US)

(21) Appl. No.: 15/224,970

(22) Filed: Aug. 1, 2016

(51) Int. Cl. B66C 23/64; B66C 23/36

(52) U.S. Cl. CPC B66C 23/64; B66C 23/36; B66C 2700/0371

(57) ABSTRACT

A linkage assembly for a machine is disclosed. The linkage assembly includes a boom and a stick pivotally coupled to a front end of the boom. The boom includes a base plate having a first portion and a second portion. The second portion is inclined at angle with respect to the first portion. The boom further includes a pair of side plates attached to the base plate, and a top plate attached to the pair of side plates. The base plate, the pair of side plates, and the top plate together define a box structure. A baffle plate is disposed within the box structure at a predefined distance from the front end of the boom. The boom further includes a mounting member attached to the base plate of the boom. The mounting member is configured to couple with a first hydraulic actuator and a second hydraulic actuator.

### TECHNICAL FIELD

The present disclosure relates to a linkage assembly for a machine.

### BACKGROUND

Machine, such as material handler is used in industries, such as scrap recycling, handling of bulk material, and forestry. The machine includes an elongated linkage assembly for accommodating different work tools. The linkage assembly includes a boom and a stick. Generally, the boom of the linkage assembly includes a top plate, a bottom plate and a pair of side plates, and multiple baffle plates. In conventional design, each of the top plate, the bottom plate, and the side plates of the boom is constructed using multiple plates attached to each other using butt weld. Typically, butt welding process is complex and time consuming compared to other types of weld joints and a butt welded location is often considered as a failure initiation location in the boom. Further, providing multiple baffle plates within a box structure of the boom increases weight of the boom. Also, installing the multiple baffle plates at multiple locations make the manufacturing of the boom complex.

U.S. Pat. No. 8,991,029, hereinafter referred to as the '029 patent, discloses a beam structure. The beam structure includes a baffle plate. A plurality of lap strips is attached around outer edges of the baffle plate. An adhesive layer is applied to outer surfaces of the lap strips. A plurality of sidewalls is assembled together around the adhesive layer, the lap strips and the baffle plate, thereby forming the beam structure. The beam structure of the '029 patent discloses the linkage assembly having multiple baffle plates and mounting arrangement of the multiple baffle plates within the beam structure.

### SUMMARY OF THE DISCLOSURE

In one aspect of the present disclosure, a linkage assembly for a machine is provided. The linkage assembly includes a boom having a front end and a rear end. The boom includes a base plate having a first portion and a second portion. The second portion is inclined at an angle with respect to the first portion. The boom further includes a pair of side plates attached to the base plate. The boom further includes a top plate attached to the pair of side plates. The base plate, the pair of side plates, and the top plate together define a box structure for the boom. Further, the boom includes a baffle plate which is disposed within the box structure at a predefined distance from the front end of the boom. The baffle plate is further attached to the base plate, the pair of side plates, and the top plate. The linkage assembly further includes a stick pivotally coupled to the front end of the boom. The linkage assembly further includes a mounting member attached to the base plate. The mounting member is configured to couple with a first hydraulic actuator and a second hydraulic actuator. Each of the first hydraulic actuator and the second hydraulic actuator is coupled to a frame of the machine and the stick, respectively.

In another aspect of the present disclosure, a linkage assembly for a machine is provided. The linkage assembly includes a boom having a front end and a rear end. The boom includes a base plate having a first portion and a second portion. The second portion is inclined at an angle with respect to the first portion. The boom further includes a first side plate attached to a first side edge of the base plate, and a second side plate spaced apart from the first side plate and attached to a second side edge of the base plate. The boom further includes a top plate attached to the first side plate and the second side plate. The base plate, the first side plate, the second side plate, and the top plate define a first T-joint and together define a box structure for the boom. The boom further includes a baffle plate disposed within the box structure of the boom at a predefined distance from the front end of the boom. The baffle plate is further attached to the base plate, the first side plate, the second side plate, and the top plate using a fillet weld. The first side plate, the second side plate, the base plate, the top plate and the baffle plate together define a chamber within the box structure for the boom. The linkage assembly further includes a stick pivotally coupled to the front end of the boom. The linkage assembly further includes a mounting member attached to the base plate to define a second T-joint. The mounting member is further configured to couple with a first hydraulic actuator and a second hydraulic actuator. Each of the first hydraulic actuator and the second hydraulic actuator is coupled to a frame of the machine and the stick, respectively.

In yet another aspect of the present disclosure, a machine is provided. The machine includes a frame and a linkage assembly coupled to the frame. The linkage assembly includes a boom having a front end and a rear end. The boom includes a base plate having a first portion and a second portion. The second portion is inclined at an angle with respect to the first portion. The boom further includes a pair of side plates attached to the base plate. A top plate of the boom is further attached to the pair of side plates. The base plate, the pair of side plates, and the top plate together define a box structure for the boom. The boom further includes a baffle plate disposed within the box structure at a predefined distance from the front end of the boom. The baffle plate is further attached to the base plate, the pair of side plates, and the top plate. The linkage assembly further includes a stick pivotally coupled to the front end of the boom. The linkage assembly further includes a mounting member attached to the base plate, and configured to couple with a first hydraulic actuator and a second hydraulic actuator. Each of the first hydraulic actuator and the second hydraulic actuator is coupled to the frame of the machine and the stick, respectively.

Other features and aspects of this disclosure will be apparent from the following description and the accompanying drawings.

### BRIEF DESCRIPTION OF THE DRAWINGS

FIG. 1 is a side view of a machine having a linkage assembly, according to one embodiment of the present disclosure;

FIG. 2 is a perspective view of a boom of the linkage assembly, according to one embodiment of the present disclosure; and

FIG. 3 is a sectional view of the boom taken along line A-A′ of FIG. 2, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

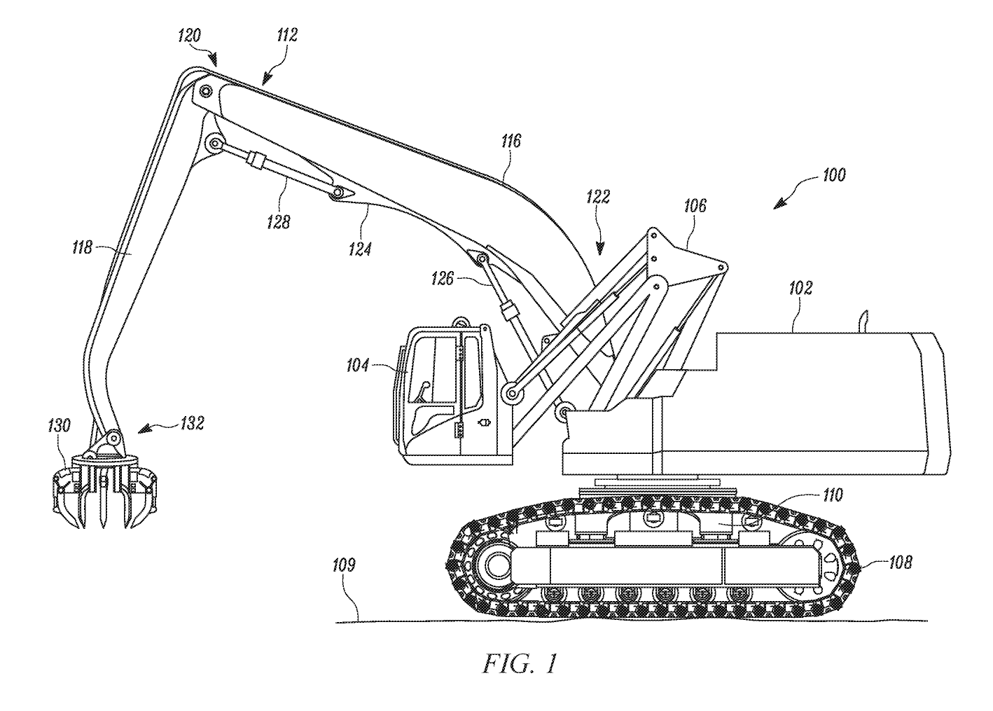

FIG. 1 illustrates a side view of a machine 100, according to one embodiment of the present disclosure. In the illustrated embodiment, the machine 100 is a material handler. In other embodiments, the machine 100 may be an excavator or a hydraulic shovel. It should be understood that the machine 100 may be associated with various industries, such as mining, construction, agriculture, and forestry. The machine 100 includes a frame 102, and an operator cabin 104 coupled to the frame 102. More specifically, the operator cabin 104 is coupled to the frame 102 of the machine 100 using a hydraulic cab riser 106. The hydraulic cab riser 106 is configured to move the operator cabin 104 with respect to the frame 102 of the machine 100. The machine 100 includes ground engaging members 108 for providing mobility to the machine 100 over a ground surface 109. In the illustrated embodiment, the ground engaging members 108 includes tracks. In an alternate embodiment, the ground engaging members 108 may include wheels. The machine 100 may further include a power source (not shown) and a drivetrain (not shown) operatively coupled to the power source and the set of ground engaging members 108. The drivetrain may be configured to transmit motive power from the power source to the set of ground engaging members 108. The machine 100 further includes a chassis 110 for supporting the frame 102, the operator cabin 104, and the set of ground engaging members 108 of the machine 100.

The machine 100 further includes a linkage assembly 112 coupled to the frame 102. The linkage assembly 112 includes a boom 116 and a stick 118. The boom 116 has a front end 120 and a rear end 122. The rear end 122 of the boom 116 is pivotally coupled to the frame 102. The front end 120 of the boom 116 is pivotally coupled to the stick 118. The linkage assembly 112 further includes a mounting member 124 that is attached to the boom 116. The mounting member 124 is coupled to a first hydraulic actuator 126 and a second hydraulic actuator 128. The first hydraulic actuator 126 is further operatively coupled to the frame 102 of the machine 100, and is configured to move the boom 116 with respect to the frame 102 of the machine 100. The second hydraulic actuator 128 is further operatively coupled to the stick 118, and is configured to move the stick 118 with respect to the boom 116. The linkage assembly 112 further includes a work tool 130 pivotally coupled to an end 132 of the stick 118 as illustrated in FIG. 1. Further, the work tool 130 may be removably coupled to the end 132 of the stick 118. As such, the work tool 130 may be selected based on application of the machine 100. In the illustrated embodiment, the machine 100 includes an orange peel grapple. In other embodiments, the work tool 130 may include, but is not limited to, a hydraulic hammer, a bucket, a grapple or a clamshell. The work tool 130 may be associated with hydraulic cylinders (not shown) and fluid line (not shown) for enabling an operation of the work tool 130.

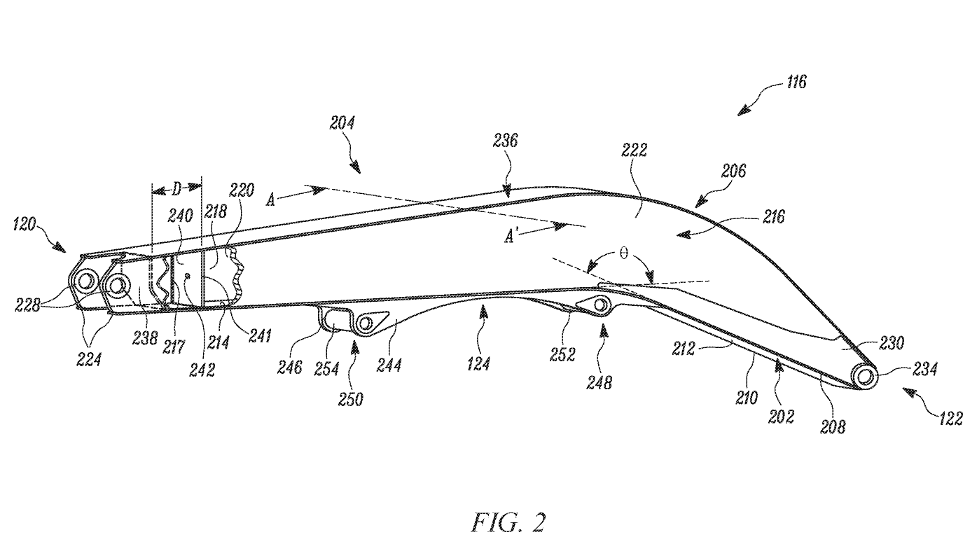

FIG. 2 illustrates a perspective view of the boom 116 of the linkage assembly 112. The rear end 122 of the boom 116 is coupled to the frame 102. The boom 116 includes a base plate 202 that is made of a metal or metal alloy, such as steel. The base plate 202 has a thickness that remains constant throughout a length of the boom 116. The base plate 202 has a first portion 204 and a second portion 206. The first portion 204 of the base plate 202 is located proximal to the front end 120 of the boom 116 and the second portion 206 is located proximal to the rear end 122 of the boom 116. The second portion 206 of the base plate 202 is inclined at an angle ‘A’ with respect to the first portion 204. The angle ‘A’ of the boom 116 may be defined based on various factors including, but not limited to, an application of the machine 100, and a load that has to be carried by the linkage assembly 112, without limiting the scope of the present disclosure. The base plate 202 has a first side edge 208 and a second side edge 210 opposite to the first side edge 208. A distance between the first side edge 208 and the second side edge 210 defines a width for the base plate 202. The base plate 202 has a bottom surface 212 and a top surface 214 opposite to the bottom surface 212. A distance between the bottom surface 212 and the top surface 214 defines the thickness for the base plate 202.

The boom 116 further includes a pair of side plates. The pair of side plates includes a first side plate 216 and a second side plate 218 spaced apart from the first side plate 216. The first side plate 216 is attached to the top surface 214 of the base plate 202 at an offset distance from the first side edge 208. Similarly, the second side plate 218 is attached to the top surface 214 of the base plate 202 at an offset distance from the second side edge 210. In an example, the first side plate 216 and the second side plate 218 may be made from a metal or metal alloy, such as steel. Each of the first and second side plates 216, 218 has an inner surface 220 and an outer surface 222 opposite to the inner surface 220. A distance between the inner surface 220 and the outer surface 222 defines a thickness for each of the first and second side plates 216, 218. In one embodiment, the thickness of each of the first and second side plates 216, 218 may be equal to the thickness of the base plate 202. In another embodiment, the thickness of each of the first and second side plates 216, 218 may be different from the thickness of the base plate 202.

A pair of first connecting members 224 is connected to each of the first and second side plates 216, 218 at the front end 120 of the boom 116 to enable coupling of the boom 116 with the stick 118. The first connecting member 224 includes a through hole 228 for receiving a pivot pin (not shown) that enables coupling of the stick 118 with the boom 116. The pair of the first connecting members 224 is attached to the first and second side plates 216, 218 by providing a lap weld joint between each of the pair of first connecting members 224 and each of the respective first and second side plates 216, 218. In the illustrated embodiment, the first connecting member 224 has a thickness greater than the thickness of the first and second side plates 216, 218. The pair of first connecting members 224 is configured to withstand a load of the stick 118 and the work tool 130.

The boom 116 further includes a first reinforcement member 230 and a second reinforcement member (not shown) attached to the first side plate 216 and the second side plate 218, respectively, proximal to the rear end 122 of the boom 116. In an embodiment, the first reinforcement member 230 and the second reinforcement member may be made of a material similar to the material of the first and second side plates 216, 218. In one embodiment, a thickness of each of the first reinforcement member 230 and the second reinforcement member may be equal to the thickness of each of the first and second side plates 216, 218, respectively. In another embodiment, the thickness of each of the first reinforcement member 230 and the second reinforcement member may be different from the thickness of each of the first and second side plates 216, 218, respectively.

The rear end 122 of the boom 116 further includes a second connecting member 234 welded to the first and second side plates 216, 218 and the first and second reinforcement members 230. The boom 116 is pivotally coupled to the frame 102 of the machine 100 using the second connecting member 234. The first and second reinforcement members 230 may increase strength of a weld provided between the second connecting member 234 and the first and second side plates 216, 218. Further, the first and second reinforcement members 230 may improve a load bearing capacity of the boom 116 owing to the additional thickness of each of the first and second side plate 216, 218 at the rear end 122 of the boom 116. In one embodiment, the second connecting member 234 may be configured to receive a connecting pin (not shown) provided in the frame 102 to enable coupling of the boom 116 with the frame 102.

The boom 116 further includes a top plate 236. The top plate 236 is attached to the first and second side plates 216, 218. In one embodiment, the top plate 236 may be a made of a metal or a metal alloy, such as steel and may have a thickness equal to the thickness of the base plate 202. The base plate 202, the first and second side plates 216, 218 and the top plate 236 together define a box structure for the boom 116. A cover plate 238 is disposed at the front end 120 of the boom 116. The cover plate 238 may be provided in the boom 116 for preventing entry of dust or other particles into the boom 116 during operation of the machine 100. In one embodiment, the cover plate 238 may be welded to the base plate 202, the first side plate 216, the second side plate 218, and the top plate 236.

The boom 116 further includes a baffle plate 240 disposed within the box structure of the boom 116 at a predefined distance ‘D’ from the front end 120 of the boom 116. In one embodiment, the predefined distance ‘D’ may be measured from a location of the cover plate 238 at the front end 120 of the boom 116. In another embodiment, the predefined distance ‘D’ may be measured from the front end 120 of the boom 116 based on various factors including, but not limited to, side load acting on the boom 116 during operation of the machine 100, and easy accessibility of the baffle plate 240 from the front end 120 of the boom 116 for a welder. In various embodiments, the predefined distance ‘D’ may be determined based on application of the machine 100. In an example, the predefined distance ‘D’ ranges from 400 mm to 500 mm. The baffle plate 240 may be made of a metal or a metal alloy, such as steel, and may have a predefined thickness. In the illustrated embodiment, the predefined thickness of the baffle plate 240 is defined based on the thickness of at least one of the base plate 202, the first and second side plates 216, 218, and the top plate 236. In an example, the predefined thickness of the baffle plate 240 may be at least 60% of the thickness of at least one of the base plate 202, the first and the second side plate 216, 218, and the top plate 236. In other embodiments, the predefined thickness of the baffle plate 240 may be defined based on various factors including, but not limited to, the side load acting on the boom 116. The baffle plate 240 is disposed perpendicular to the base plate 202. In another embodiment, the baffle plate 240 may be disposed at a predefined angle ‘0’ with respect to the base plate 202. In an example, the predefined angle ‘0’ may range from 80° to 110°.

The baffle plate 240 has a plurality of side edges 241. In the illustrated embodiment, the baffle plate 240 includes four side edges. Each of the plurality of side edges 241 of the baffle plate 240 is attached to the base plate 202, the first side plate 216, the second side plate 218, and the top plate 236 using a fillet weld 217. In the illustrated embodiment, each of the plurality of side edges 241 of the baffle plate 240 is provided with a chamfering portion (not shown) to define a single bevel grove, and hence to provide the fillet weld 217 along the plurality of side edges 241 of the baffle plate 240. The base plate 202, the first side plate 216, the second side plate 218, the top plate 236, and the baffle plate 240 together define a chamber within the box structure of the boom 116. The baffle plate 240 includes a through hole 242 to allow air to flow in and out of the chamber of the boom 116, which may otherwise cause air block in the chamber during manufacturing of the boom 116. Thus, the boom 116 of the present disclosure is provided with the single baffle plate 238 at the front end 120 of the boom 116 to achieve a desired strength of the boom 116.

Referring to FIG. 1 and FIG. 2, the linkage assembly 112 further includes the mounting member 124. The mounting member 124 is attached to the bottom surface 212 of the base plate 202. The mounting member 124 includes a first mounting plate 244 and a second mounting plate 246. In the illustrated embodiment, the first mounting plate 244 is attached to the base plate 202 at an offset distance from the first side edge 208 of the base plate 202. Similarly, the second mounting plate 246 is attached to the base plate 202 at an offset distance from the second side edge 210 of the base plate 202. The mounting member 124 has a first end 248 proximal to the rear end 122 of the boom 116 and a second end 250 proximal to the front end 120 of the boom 116.

The mounting member 124 further includes a first pivot pin 252 and a second pivot pin 254 spaced apart from the first pivot pin 252. The first pivot pin 252 and the second pivot pin 254 are connected to the first end 248 and the second end 250, respectively, of the mounting member 124. The first pivot pin 252 is configured to couple the first hydraulic actuator 126 for moving the boom 116 with respect to the frame 102 of the machine 100. The second pivot pin 254 is configured to couple the second hydraulic actuator 128 for moving the stick 118 with respect to the boom 116 of the linkage assembly 112.

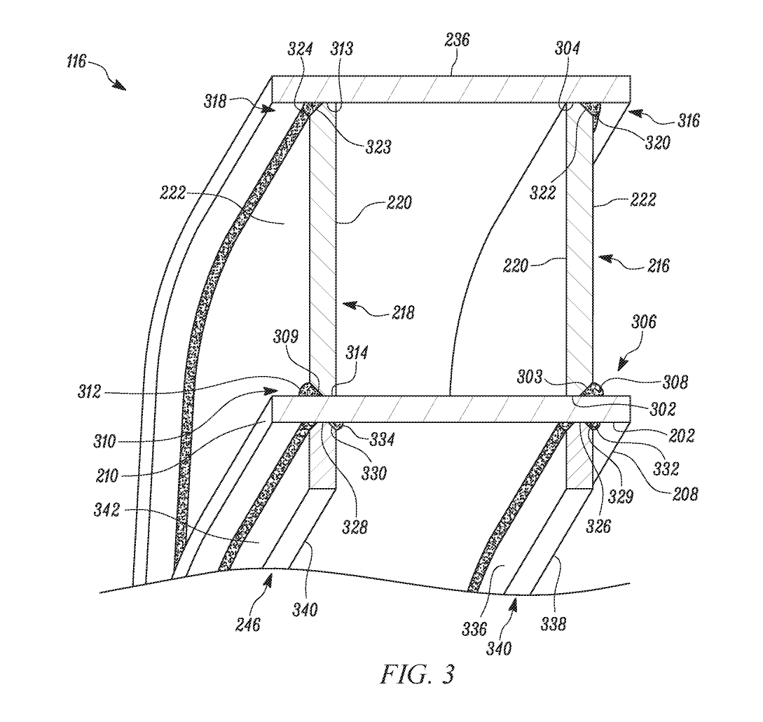

FIG. 3 illustrates a sectional view of the boom 116 taken along a line A-A′ of FIG. 2. As mentioned earlier, the boom 116 includes the base plate 202, the first and second side plates 216, 218, and the top plate 236, which together define the box structure for the boom 116. Each of the first side plate 216 and the second side plate 218 includes the inner surface 220 and the outer surface 222.

In order to attach the first side plate 216 with the base plate 202, a chamfering portion 303 is provided along a length of a bottom end 302 of the first side plate 216. More specifically, the chamfering portion 303 extends from the outer surface 222 of the first side plate 216, as shown in FIG. 3. In the illustrated embodiment, the first side plate 216 is positioned at an offset distance from the first side edge 208 of the base plate 202, and is disposed perpendicular to the top surface 214 (as shown in FIG. 2) of the base plate 202 so as to define a first T-joint 306 between the first side plate 216 and the base plate 202. In another embodiment, the first side plate 216 may be positioned at an angle with respect to the top surface 214 of the base plate 202. Thus, a single bevel groove 308 is formed between the bottom end 302 of the first side plate 216 and the base plate 202. The first side plate 216 is further attached to the base plate 202 by providing a fillet weld along the single bevel groove 308 formed between the first side plate 216 and the base plate 202.

In order to attach the second side plate 218 with the base plate 202, a chamfering portion 309 is provided along a length of a bottom end 314 of the second side plate 218. The second side plate 218 is positioned at an offset distance from the second side edge 210, and is disposed perpendicular to the top surface 214 of the base plate 202 so as to define a first T-joint 310 between the second side plate 218 and the base plate 202. Thus, a single bevel groove 312 is formed between the bottom end 314 of the second side plate 218 and the base plate 202. The second side plate 218 is further attached to the base plate 202 of the boom 116 by providing a fillet weld along the single bevel groove 312 formed between the second side plate 218 and the base plate 202.

In order to form the box structure of the boom 116, the top plate 236 is attached to the first side plate 216 and the second side plate 218. More specifically, the top plate 236 is disposed perpendicular to each of the first side plate 216 and the second side plate 218. Owing to the perpendicular positioning of the first side plate 216 with the top plate 236, a first T-joint 316 is defined between the first side plate 216 and the top plate 236. Further, a chamfering portion 322 is provided along a length of a top end 304 of the first side plate 216. A single bevel groove 320 is formed between the top end 304 of the first side plate 216 and the top plate 236. The first side plate 216 is further attached to the top plate 236 by providing a fillet weld along the single bevel groove 320 defined between the first side plate 216 and the top plate 236. Similarly, the top plate 236 is disposed perpendicular to the second side plate 218. Owing to the perpendicular positioning of the second side plate 218 with the top plate 236, a first T-joint 318 is defined between the second side plate 218 and the top plate 236. Further, a chamfering portion 323 is provided along a length of a top end 313 of the second side plate 218. Thus, a single bevel groove 324 is formed between the top end 313 of the second side plate 218 and the top plate 236. The second side plate 218 is further attached to the top plate 236 by providing a fillet weld along the single bevel groove 324 formed between the second side plate 218 and the top plate 236.

As mentioned earlier, the mounting member 124 is attached to the base plate 202 of the boom 116. The first mounting plate 244 is positioned at an offset distance from the first side edge 208 of the base plate 202, and the second mounting plate 246 is positioned at an offset distance from the second side edge 210 of the base plate 202. In order to attach the mounting member 124 to the base plate 202, a chamfering portion 329 is provided from each of an inner surface 336 and an outer surface 338 of a top end 326 of the first mounting plate 244. Similarly, a chamfering portion 330 is provided from an inner surface 340 and an outer surface 342 of a top end 328 of the second mounting plate 246.

Each of the first mounting plate 244 and the second mounting plate 246 is positioned perpendicular to the bottom surface 212 of the base plate 202. Owing to the perpendicular positioning of the first mounting plate 244 with the base plate 202, a second T-joint is defined between the first mounting plate 244 and the base plate 202. Thus, a double bevel groove 332 is formed between the top end 326 of the first mounting plate 244 and the bottom surface 212 of the base plate 202. The first mounting plate 244 is further attached to the base plate 202 of the boom 116 by providing a fillet weld along the double bevel groove 332 formed between the first mounting plate 244 and the base plate 202. Similarly, the perpendicular positioning of the second mounting plate 246 with the base plate 202, a second T-joint is defined between the second mounting plate 246 and the base plate 202. Further, a double bevel groove 334 is formed between the top end 328 of the second mounting plate 246 and the bottom surface 212 of the base plate 202. The second mounting plate 246 is further attached to the base plate 202 by providing a fillet weld along the double bevel groove 334 formed between the second mounting plate 246 and the base plate 202.

### INDUSTRIAL APPLICABILITY

The present disclosure relates to the linkage assembly 112 for the machine 100. The linkage assembly 112 includes the boom 116, which is formed by attaching the base plate 202, the first and second side plates 216, 218, and the top plate 236 with each other. Each of the base plate 202, the first and second side plates 216, 218, and the top plate 236 is made of a single metal piece without any weld joints, such as butt weld joints. Thus, the single metal piece construction of the base plate 202, the first and second side plates 216, 218, and the top plate 236 increases load bearing capacity of the boom 116. Further, the first T-joints 306, 310, 316, and 318 provided between the base plate 202, the first and second side plates 216, 218, and the top plate 236 improve reliability and durability of the boom 116. In order to attach the base plate 202, the first and second side plates 216, 218, and the top plate 236 with each other, the top ends 304 and 313 of each of the first and second side plates 216, 218 are provided with the chamfering portions 322, 323, 329, and 330, respectively. The chamfering portions 322, 323, 329, and 330 of the first and second side plates 216, 218 provide an increased joint and root penetration along the length of each of the top ends 304, 313 and the bottom ends 302, 314 of the first side plate 216 and the second side plate 218, respectively. Each of the base plate 202, the first and second side plates 216, 218, and the top plate 236 is attached to each other by forming the fillet welds along the single bevel grooves 308, 312, 320, and 324 to improve fatigue strength of the boom 116, and thereby reduce localized stress acting on the boom 116.

The baffle plate 240 is disposed within the box structure of the boom 116 at the predefined distance ‘D’ from the front end 120 of the boom 116. The predefined distance ‘D’ may be determined in such a way that the baffle plate 240 may be accessed by the welder, and eliminate complexity in construction of the boom 116. Further, the baffle plate 240 is attached to the boom 116 by providing the fillet weld 217 along each of the plurality of side edges 241 of the baffle plate 240, the top plate 236, the first and second side plates 216, 218, and the base plate 202. The fillet weld reduces localized stress acting on the baffle plate 240. Owing to the positioning of the single baffle plate 240 at the predefined distance ‘D’, the linkage assembly 112 is able to achieve desired side load bearing capacity. Thus the single piece construction of the boom 116 along with the single baffle plate 240 at an optimized distance from the front end 120 of the boom 116 provides the desired strength of the boom 116 with less cost and reduced complexity in manufacturing and assembly of the boom 116. Attaching the mounting member 124 to the bottom surface 212 of the base plate 202 of the boom 116 facilitates coupling of the first and second hydraulic actuators 126, 128 without making any alteration or modification in the base plate 202, the first side plate 216, the second side plate 218, or the top plate 236.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A linkage assembly for a machine, comprising:
a boom having a front end and a rear end, the boom comprising:
a base plate having a first portion and a second portion, wherein the second portion is inclined at an angle with respect to the first portion;
a pair of side plates attached to the base plate;
a top plate attached to the pair of side plates, wherein the base plate, the pair of side plates, and the top plate together define a box structure for the boom; and
a baffle plate disposed within the box structure at a predefined distance from the front end of the boom, and attached to the base plate, the pair of side plates, and the top plate;
a stick pivotally coupled to the front end of the boom; and
a mounting member attached to the base plate, and configured to couple with a first hydraulic actuator and a second hydraulic actuator, wherein each of the first hydraulic actuator and the second hydraulic actuator is coupled to a frame of the machine and the stick, respectively.

2. The linkage assembly of claim 1 comprising, a cover plate disposed at the front end of the boom, wherein the predefined distance is measured between the baffle plate and the cover plate.

3. The linkage assembly of claim 1, wherein the pair of side plates comprises:
a first side plate attached to a first side edge of the base plate; and
a second side plate spaced apart from the first side plate, and attached to a second side edge of the base plate, wherein the first side plate, the second side plate, the base plate, the top plate, and the baffle plate together define a chamber within the box structure for the boom.

4. The linkage assembly of claim 1, wherein the mounting member comprises:
a first pivot pin configured to couple with the first hydraulic actuator, wherein the first hydraulic actuator moves the boom with respect to the frame of the machine; and
a second pivot pin spaced apart from the first pivot pin, and configured to couple with the second hydraulic actuator, wherein the second hydraulic actuator moves the stick with respect to the boom.

5. The linkage assembly of claim 1, wherein a first T-joint is defined between each of the pair of side plates and at least one of the top plate and the base plate.

6. The linkage assembly of claim 5, wherein the first T-joint comprises a single bevel-groove weld.

7. The linkage assembly of claim 1, wherein a second T-joint is defined between the mounting member and the base plate, and wherein the second T-joint comprises a double bevel-groove weld.

8. The linkage assembly of claim 1, wherein the baffle plate is attached to the base plate, the top plate, and each of the pair of side plates using a fillet weld.

9. A linkage assembly for a machine, comprising:
a boom having a front end and a rear end, the boom comprising:
a base plate having a first portion and a second portion, wherein the second portion is inclined at an angle with respect to the first portion;
a first side plate attached to a first side edge of the base plate;
a second side plate spaced apart from the first side plate, and attached to a second side edge of the base plate;
a top plate attached to the first side plate and the second side plate, wherein the base plate, the first side plate, the second side plate, and the top plate defining a first T-joint and together define a box structure for the boom; and
a baffle plate disposed within the box structure of the boom at a predefined distance from the front end of the boom, and attached to the base plate, the first side plate, the second side plate, and the top plate using a fillet weld, wherein the first side plate, the second side plate, the base plate, the top plate, and the baffle plate together define a chamber within the box structure for the boom;
a stick pivotally coupled to the front end of the boom; and
a mounting member attached to the base plate to define a second T-joint, and configured to couple with a first hydraulic actuator and a second hydraulic actuator, wherein each of the first hydraulic actuator and the second hydraulic actuator is coupled to a frame of the machine and the stick, respectively.

10. The linkage assembly of claim 9 comprising a cover plate disposed at the front end of the boom, wherein the predefined distance is measured between the baffle plate and the cover plate.

11. The linkage assembly of claim 9, wherein the mounting member comprises:
a first pivot pin configured to couple with the first hydraulic actuator, wherein the first hydraulic actuator moves the boom with respect to the frame of the machine; and
a second pivot pin spaced apart from the first pivot pin, and configured to couple with the second hydraulic actuator, wherein the second hydraulic actuator moves the stick with respect to the boom.

12. The linkage assembly of claim 9, wherein the first T-joint comprises a single bevel-groove weld.

13. The linkage assembly of claim 9, wherein the second T-joint defined between the mounting member and the base plate comprises a double bevel-groove weld.

14. A machine comprising:
a frame; and
a linkage assembly coupled to the frame, the linkage assembly comprising:
a boom having a front end and a rear end, the boom comprising:
a base plate having a first portion and a second portion,
wherein the second portion is inclined at an angle with respect to the first portion;
a pair of side plates attached to the base plate;
a top plate attached to the pair of side plates, wherein the base plate, the pair of side plates, and the top plate together define a box structure for the boom; and
a baffle plate disposed within the box structure at a predefined distance from the front end of the boom, and attached to the base plate, the pair of side plates, and the top plate;
a stick pivotally coupled to the front end of the boom; and
a mounting member attached to the base plate, and configured to couple with a first hydraulic actuator and a second hydraulic actuator, wherein each of the first hydraulic actuator and the second hydraulic actuator is coupled to the frame of the machine and the stick, respectively.

15. The machine of claim 14, wherein the linkage assembly comprises a cover plate disposed at the front end of the boom, wherein the predefined distance is measured between the baffle plate and the cover plate.

16. The machine of claim 14, wherein the mounting member comprises:
a first pivot pin configured to couple with the first hydraulic actuator, wherein the first hydraulic actuator moves the boom with respect to the frame of the machine; and
a second pivot pin spaced apart from the first pivot pin, and configured to couple with the second hydraulic actuator, wherein the second hydraulic actuator moves the stick with respect to the boom.

17. The machine of claim 14, wherein a first T-joint is defined between each of the pair of side plates and at least one of the top plate and the base plate.

18. The machine of claim 17, wherein the first T-joint comprises a single bevel-groove weld.

19. The machine of claim 14, wherein a second T-joint is defined between the mounting member and the base plate, and wherein the second T-joint comprises a double bevel-groove weld.

20. The machine of claim 14, wherein the baffle plate is attached to the base plate, the top plate, and each of the pair of side plates using a fillet weld.
